(19) United States
(12) Patent Application Publication
(10) Pub. No.: US 2021/0295344 A1
(43) Pub. Date: Sep. 23, 2021

(54) CUSTOMER RELATION MANAGEMENT DEVICE AND METHOD

(71) Applicant: DENTSU INC., Tokyo (JP)

(72) Inventors: Kohei WASHIO, Tokyo (JP); Satoshi ISHIGAI, Tokyo (JP); Kunihiko MONBU, Tokyo (JP)

(73) Assignee: DENTSU INC., Tokyo (JP)

(21) Appl. No.: 17/341,310

(22) Filed: Jun. 7, 2021

Related U.S. Application Data
(63) Continuation-in-part of application No. 15/771,717, filed on Apr. 27, 2018, now abandoned.

(30) Foreign Application Priority Data
Nov. 9, 2015 (JP) 2015-219076

(51) Int. Cl. G06Q 30/00; G06Q 30/02; G06F 16/901; G06F 16/9035; G06F 16/9038

(52) U.S. Cl. CPC G06Q 30/01; G06Q 30/0282; G06F 16/9038; G06F 16/9035; G06F 16/9017

(57) ABSTRACT

A customer relation management device creates an evaluation map (a map where information pertaining to customer relation management is arranged in a coordinate space with evaluation axes serving as the reference for evaluating information, according to an evaluation result with the evaluation axes being regarded as an index), determines temporary coordinates where process target data is temporarily arranged in the coordinate space, according to an evaluation of the process target data with the evaluation axes being regarded as the index, when newly obtained information pertaining to customer relation management is input as the process target data, and recommends the process target data, based on the temporary coordinates on the evaluation map. After the recommendation, the device determines the coordinates where the process target data is to be arranged according to evaluation information (evaluation data) obtained with respect to the process target data.

### TECHNICAL FIELD

The present invention relates to a customer relation management device that constructs a relationship with a customer and improves the customer satisfaction.

### BACKGROUND ART

Customer relation management (CRM) is a method of constructing a relationship with a customer and improving the customer satisfaction, and has been expected to be used in various fields in recent years. Conventionally, a method of providing user-centered feedback analysis in customer relation management has been proposed (for example, see Patent Literature 1).

The conventional method obtains a feedback record from feedback pertaining to a product with respect to each user having provided the feedback pertaining to the product, and generates a user preference profile on the basis of the feedback record. Each feedback record is obtained from specific feedback provided by the user related to a specific product. The user preference profile includes user preference vectors corresponding to products. Each user preference vector has features of the corresponding product, and feature scores corresponding to the respective features.

### CITATION LIST

### Patent Literature

Patent Literature 1: Japanese Patent Laid-Open No. 2013-69285

### SUMMARY OF INVENTION

### Technical Problem

Unfortunately, conventional customer relation management has a problem in that it is difficult for ordinary people to understand the analysis result because mathematical data processing is used. Accordingly, development of a method of allowing even ordinary people to understand easily the analysis result, has been desired. Furthermore, development of a technique of reflecting, in subsequent analysis, a result of proposal (recommendation) of a product to a customer based on the analysis result, has been desired.

The present invention has been made in view of the above problem, and has an object to provide a customer relation management device that allows an analysis result to be easily understood, and that can reflect, in a subsequent analysis, a result of recommendation made on the basis of the analysis result.

### Solution to Problem

A customer relation management device of the present invention includes: an evaluation map creation unit that creates an evaluation map where information pertaining to customer relation management is arranged in a coordinate space with evaluation axes serving as a reference for evaluating the information, according to an evaluation result of the information with the evaluation axes being regarded as an index; a process target data input unit that receives newly obtained information pertaining to customer relation management, as process target data; a temporary coordinate determination unit that determines temporary coordinates where the process target data is temporarily arranged in the coordinate space according to the evaluation of the process target data with the evaluation axes being regarded as an index; a recommendation unit that recommends the process target data, based on the temporary coordinates on the evaluation map; an evaluation data obtaining unit that obtains, as evaluation data, evaluation information acquired with respect to the process target data, after the recommendation; and a coordinate arrangement determination unit that determines coordinates where the process target data is to be arranged in the coordinate space, according to the evaluation data.

According to this configuration, the information pertaining to customer relation management is arranged in the coordinate space on the evaluation map according to the evaluation result of the information. The evaluation map allows the analysis result to be easily and intuitively understood even by a person who is not an expert (even by an ordinary person). In a case where new information pertaining to customer relation management (process target data) is input, the information is temporarily arranged in the coordinate space on the evaluation map according to the evaluation result of the information, recommendation is performed on the basis of the temporarily arranged position (temporary coordinates), and subsequently the position (coordinates) where the information is to be rearranged is appropriately determined on the basis of the evaluation information (evaluation data) obtained with respect to the information. As described above, the result of recommendation based on the analysis result is reflected in the evaluation map. Accordingly, the result of the recommendation can be reflected in analysis thereafter.

In the customer relation management device of the present invention, the evaluation data may be input as new process target data, into the process target data input unit.

According to this configuration, as a result of the recommendation of the process target data, the evaluation information (evaluation data) obtained with respect to the information is input as new process target data and arranged on the evaluation map. Accordingly, not only the original information (process target data) but also the evaluation information (evaluation data) on the original information can be used for customer relation management.

In the customer relation management device of the present invention, the evaluation map creation unit may re-create the evaluation map according to the evaluation data.

According to this configuration, the evaluation map itself is re-created (updated) according to the result of the recommendation (evaluation data). Accordingly, the result of the recommendation can be reflected in the entire evaluation map.

In the customer relation management device of the present invention, the recommendation unit: may create a recommendation list where pieces of the information pertaining to customer relation management arranged on the evaluation map are arranged sequentially from the piece nearest to the temporary coordinates of the process target data; and may recommend the process target data, based on the recommendation list.

According to this configuration, the recommendation is performed on the basis of the temporary coordinates on the evaluation map. On the evaluation map, the proximity between certain process target data and the position (coordinates) of arrangement in the coordinate space on the evaluation map means a high correlation with the process target data. In this case, the recommendation is performed on the basis of the recommendation list where pieces of information are arranged sequentially from the nearest to the temporary coordinates of the process target data. That is, the recommendation is performed sequentially from the nearest to the temporary coordinates of the process target data. Consequently, appropriate recommendation can be performed.

A method of the present invention is a method executed in a customer relation management device, wherein the customer relation management device creates an evaluation map where information pertaining to customer relation management is arranged in a coordinate space with evaluation axes serving as a reference for evaluating the information, according to an evaluation result of the information with the evaluation axes being regarded as an index, and the method includes: determining temporary coordinates when newly obtained information pertaining to customer relation management is input as process target data, the temporary coordinates allowing the process target data to be temporarily arranged in the coordinate space according to an evaluation of the process target data with the evaluation axes being regarded as an index; recommending the process target data, based on the temporary coordinates on the evaluation map; obtaining, as evaluation data, evaluation information acquired with respect to the process target data, after the recommendation; and determining coordinates where the process target data is to be arranged in the coordinate space, according to the evaluation data.

Also according to this method, in a manner analogous to that in the above description, the information pertaining to customer relation management is arranged in the coordinate space on the evaluation map according to the evaluation result of the information. Consequently, the evaluation map allows the analysis result to be easily and intuitively understood even by a person who is not an expert (even by an ordinary person). In a case where new information pertaining to customer relation management (process target data) is input, the information is temporarily arranged in the coordinate space on the evaluation map according to the evaluation result of the information, recommendation is performed on the basis of the temporarily arranged position (temporary coordinates), and subsequently the position (coordinates) where the information is to be rearranged is appropriately determined on the basis of the evaluation information (evaluation data) obtained with respect to the information. As described above, the result of recommendation based on the analysis result is reflected in the evaluation map. Accordingly, the result of the recommendation can be reflected in analysis thereafter.

### Advantageous Effects of Invention

The present invention can allow easy and intuitive understanding of an analysis result, and reflect, in a subsequent analysis, a result of recommendation made on the basis of the analysis result.

### BRIEF DESCRIPTION OF DRAWINGS

FIG. 1 is a block diagram of a customer relation management device according to an embodiment of the present invention.

FIG. 2 is a flowchart for illustrating operations of the customer relation management device according to the embodiment of the present invention.

FIG. 3 is a diagram showing an example of an evaluation map according to the embodiment of the present invention.

FIG. 4 is a diagram showing an example of the evaluation map according to the embodiment of the present invention.

FIG. 5 is a diagram showing an example of the evaluation map according to the embodiment of the present invention.

FIG. 6 is a diagram showing an example of the evaluation map according to the embodiment of the present invention.

FIG. 7 is a diagram showing an example of the evaluation map according to the embodiment of the present invention.

FIG. 8 is a diagram showing an example of the evaluation map according to the embodiment of the present invention.

FIG. 9 is a diagram showing an example of the evaluation map according to the embodiment of the present invention.

### DESCRIPTION OF EMBODIMENTS

Hereinafter, a customer relation management device according to an embodiment of the present invention is described with reference to the drawings. This embodiment exemplifies a case of use for customer relation management in the ramen business.

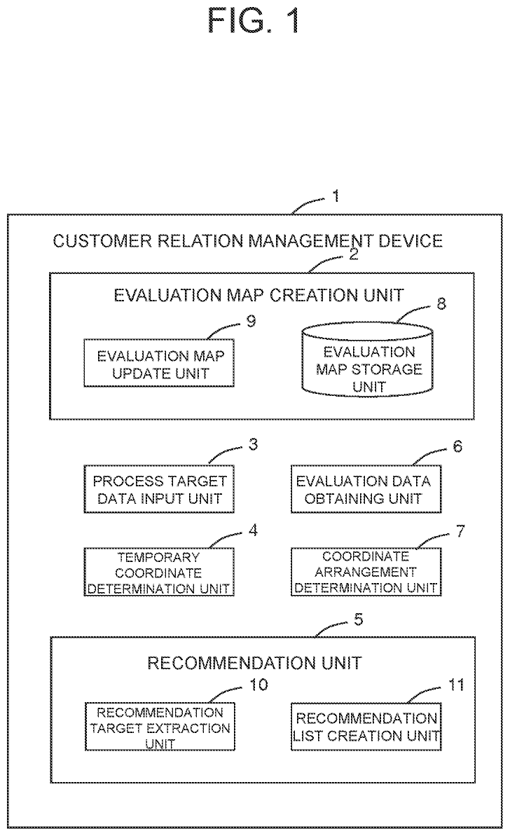

The configuration of the customer relation management device according to the embodiment of the present invention is described with reference to the drawings. FIG. 1 is a block diagram showing a customer relation management device 1 according to this embodiment. As shown in FIG. 1, the customer relation management device 1 includes an evaluation map creation unit 2, a process target data input unit 3, a temporary coordinate determination unit 4, a recommendation unit 5, an evaluation data obtaining unit 6, and a coordinate arrangement determination unit 7. The customer relation management device 1 may include a processor, such as a central processing unit (CPU), configured to control the operation of each unit and a memory configured to store various data. The customer relation management device 1 may further include a user interface configured to display various data, such as recommendations. The user interface may be a part of, or in communication with, the customer relation management device 1.

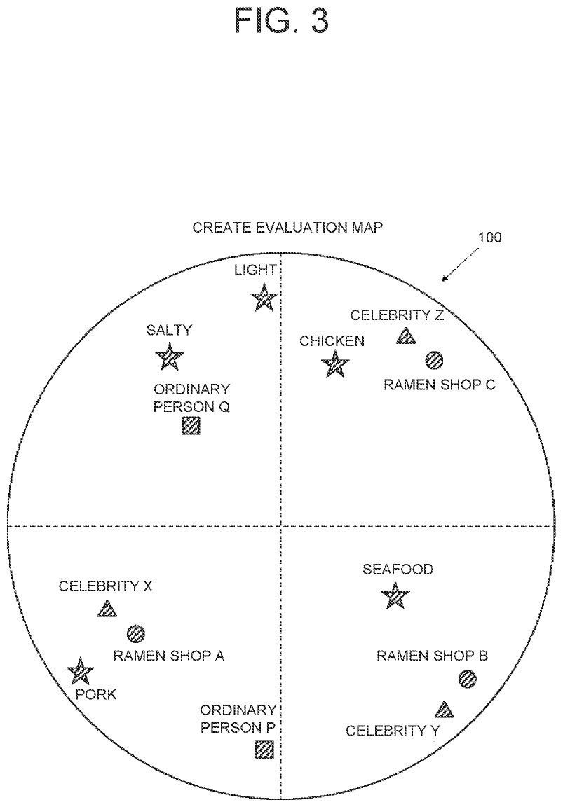

The evaluation map creation unit 2 has a function of creating an evaluation map. The evaluation map is a map where information pertaining to customer relation management is arranged in a coordinate space with evaluation axes serving as a reference for evaluating information, according to an evaluation result of information with the evaluation axes being regarded as an index (see FIGS. 3 to 8).

In an example in FIG. 3, information, such as “brand (ramen shops A, B, C, . . . )”, “people (ordinary people P, Q, . . . , celebrities X, Y, Z, . . . )”, and “keywords (light, salty, chicken, pork, seafood, . . . )” is arranged, as the information pertaining to customer relation management, on the map. The pieces of information pertaining to customer relation management can be collected through various methods (e.g., a web research), and are arranged in the coordinate space (vector space) with an evaluation axis serving as an evaluation reference for the information, according to the evaluation result of the information with the evaluation axis (e.g., preference) being regarded as an index.

This evaluation map shows that as the positions where the pieces of information are arranged are near to each other, the evaluation results of the pieces of information are similar to each other and the mutual relationship is strong. For instance, the example in FIG. 3 shows that information on the keyword “pork”, the brand “ramen shop A”, and the person “celebrity X” have similar evaluation results with reference to the preference (have strong relationships with each other).

The evaluation map creation unit 2 includes an evaluation map storage unit 8 that stores the created evaluation map, and an evaluation map update unit 9 that re-creates (updates) the evaluation map. A publicly known technique can be used to create and re-create (update) the evaluation map.

Newly obtained information pertaining to customer relation management (e.g., the brand “ramen shop D”, the person “ordinary person R”, the keyword “salty, fish and pork”, etc.) is input as process target data into the process target data input unit 3. The process target data can be obtained from meta information accompanying the newly obtained information (content, brand, person, and keyword). The temporary coordinate determination unit 4 determines temporary coordinates where process target data is temporarily arranged in the coordinate space according to the evaluation of the process target data with the evaluation axes (e.g., preference) of the evaluation map being regarded as an index. The method of determining (rearranging in the coordinate space) the temporary coordinates of the process target data (newly obtained information pertaining to customer relation management) is analogous to arrangement of the information pertaining to customer relation management into the coordinate space in the evaluation map creation described above.

The recommendation unit 5 recommends the process target data on the basis of the temporary coordinates on the evaluation map. The recommendation unit 5 includes a recommendation target extraction unit 10, and a recommendation list creation unit 11.

The recommendation target extraction unit 10 extracts pieces of information near to the temporary coordinates of the process target data from among all the pieces of information pertaining to customer relation management arranged on the evaluation map. For example, pieces of information having an angle on the evaluation map centered on the process target data within a predetermined angle (within N degrees). Alternatively, pieces of information having a distance from the process target data on the evaluation map within a predetermined distance (within a distance D). The predetermined angle N and the predetermined distance D can be appropriately determined according to the total number of recommendations.

The recommendation list creation unit 11 creates a list (recommendation list) where the extracted pieces of information pertaining to customer relation management are arranged in an order sequentially from the nearest to the temporary coordinates of the process target data. For example, a recommendation list is created where the pieces are arranged sequentially from the piece having the closest angle on the evaluation map centered on the process target data. Alternatively, a recommendation list is created where the pieces are arranged sequentially from the piece having the shortest distance from the process target data on the evaluation map.

The recommendation unit 5 recommends the process target data on the basis of the recommendation list created as described above. The recommendation may be performed according to any of various known methods. For example, recommendation may be performed through a web site or email.

After recommendation, the evaluation data obtaining unit 6 obtains, as the evaluation data, evaluation information (e.g., evaluations by ordinary people P and Q) obtained with respect to the process target data (e.g., ramen shop D). The coordinate arrangement determination unit 7 determines coordinates where the process target data (e.g., ramen shop D) is to be arranged in the coordinate space according to the evaluation data. The evaluation data described above (e.g., the keyword “salty, fish and pork” in the evaluations by ordinary people Q and R) may be input as new process target data into the process target data input unit 3. The evaluation map update unit 9 may have a function of re-creating (updating) the entire evaluation map according to the evaluation data.

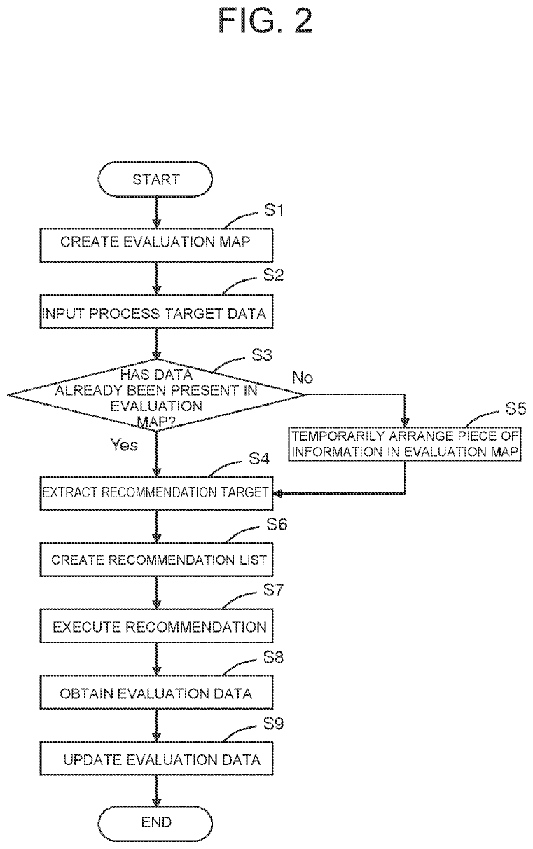

The operations of the customer relation management device 1 having the configuration described above are described with reference to the drawings. FIG. 2 is a flowchart for illustrating the flow of operations. FIGS. 3 to 8 are diagrams showing examples of the evaluation maps.

As shown in FIG. 2, the customer relation management device 1 of this embodiment collects information pertaining to customer relation management, and creates the evaluation map (S1). When new information pertaining to customer relation management is input as the process target data (S2), it is determined whether the process target data has already been present in the evaluation map (S3).

In a case where the process target data has already been present in the evaluation map, a piece near to the coordinates of the process target data is extracted as a recommendation target from among all the pieces of information pertaining to customer relation management arranged on the evaluation map (S4). On the contrary, in a case where the process target data is absent from the evaluation map, temporary coordinates for temporarily arranging the process target data on the evaluation map are determined (S5), and a piece near to the temporary coordinates of the process target data are extracted as a recommendation target from among all the pieces of information pertaining to customer relation management arranged on the evaluation map (S4).

The recommendation list where the pieces of information are arranged from the nearest to the coordinates or temporary coordinates of the process target data is created (S6), and the process target data is recommended on the basis of the recommendation list (S7). After the recommendation, the evaluation information acquired with respect to the process target data is obtained as the evaluation data (S8). Coordinates for arranging the process target data in the coordinate space are determined according to the evaluation data, or the evaluation map is re-created (updated) according to the evaluation data (S9).

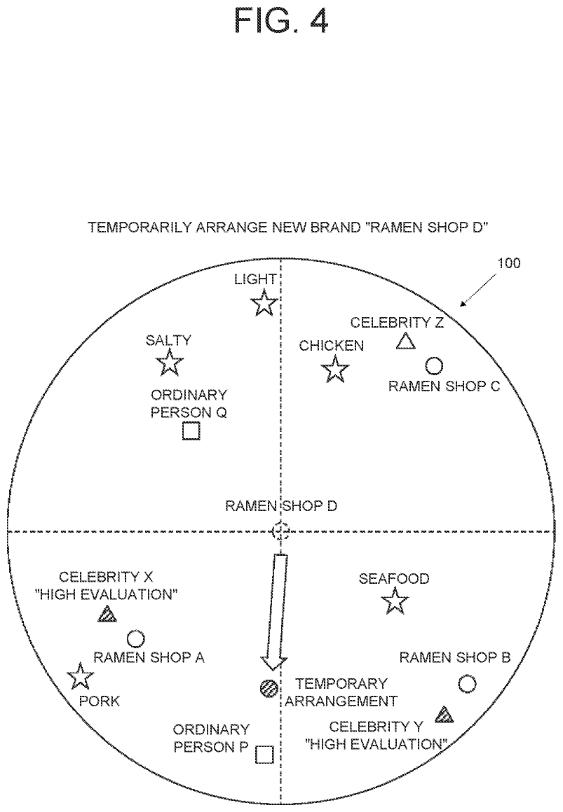

The flow of the operations of the customer relation management device 1 as described above is described on the basis of the examples of the evaluation maps. First, for example, through web research, information pertaining to customer relation management with respect to the ramen business (brand, person, keyword, content, etc.) is collected, and the evaluation map as shown in FIG. 3 is created. Next, new information pertaining to customer relation management (e.g., the new brand “ramen shop D” that is not on the evaluation map) is input as the process target data, and then the temporary coordinates of the process target data are determined as shown in FIG. 4.

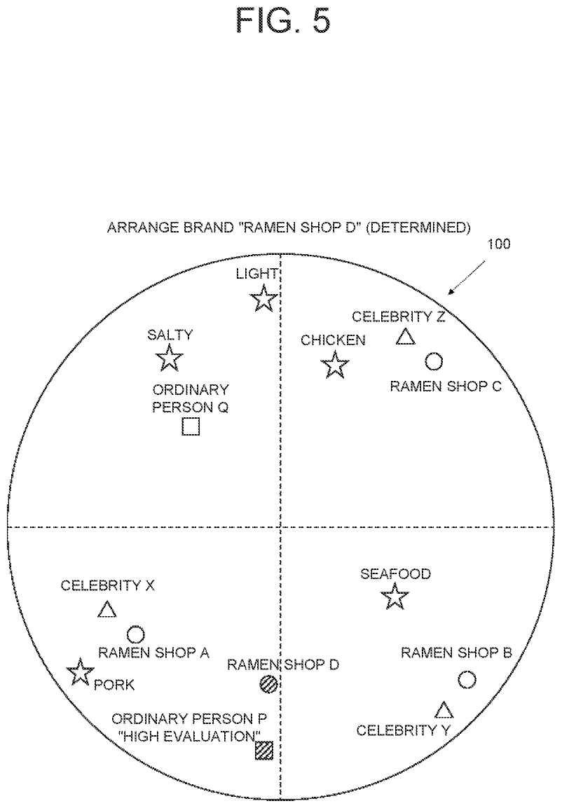

If the evaluation information obtained with respect to the process target data is “a high evaluation by an ordinary person P” as a result of recommendation of the process target data (ramen shop D) based on the temporary coordinates, coordinates for arranging the process target data in the coordinate space are determined on the basis of the evaluation information (evaluation data). In this case, as shown in FIG. 5, the process target data (ramen shop D) is arranged at a position (coordinates) near to the “ordinary person P”.

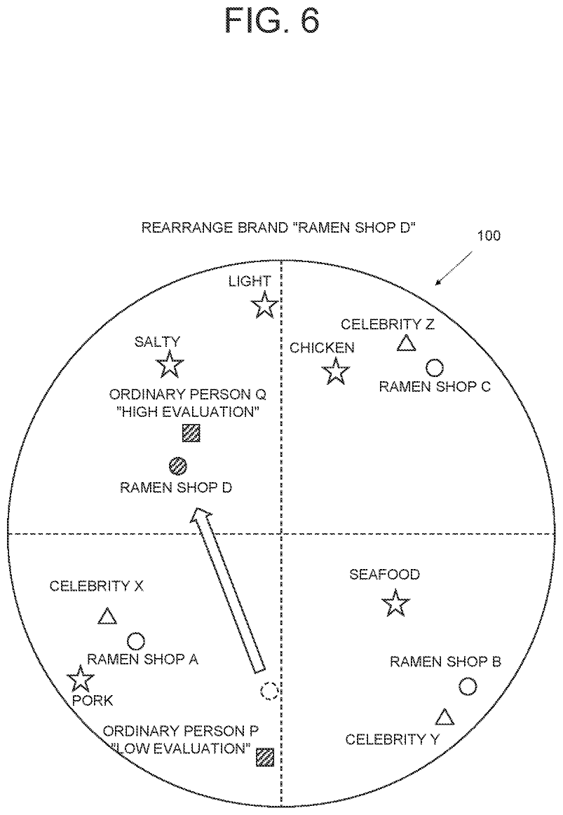

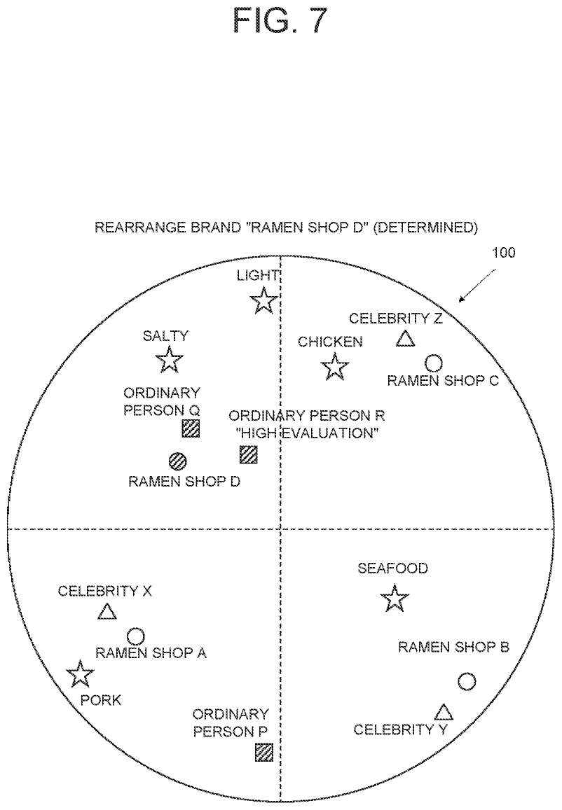

On the contrary, if the evaluation information obtained with respect to the process target data is “a low evaluation by the ordinary person P” and “a high evaluation by an ordinary person Q”, the process target data (ramen shop D) is rearranged at a position (temporary coordinates) far from the “ordinary person P” and near to the “ordinary person Q” as shown in FIG. 6. Subsequently, if the evaluation information obtained with respect to the process target data is “a high evaluation by an ordinary person R” as a result of recommendation of the process target data (ramen shop D) based on the rearranged temporary coordinates, the process target data (ramen shop D) is arranged at a position (coordinates) near to the “ordinary person R” (and “ordinary person Q”) as shown in FIG. 7.

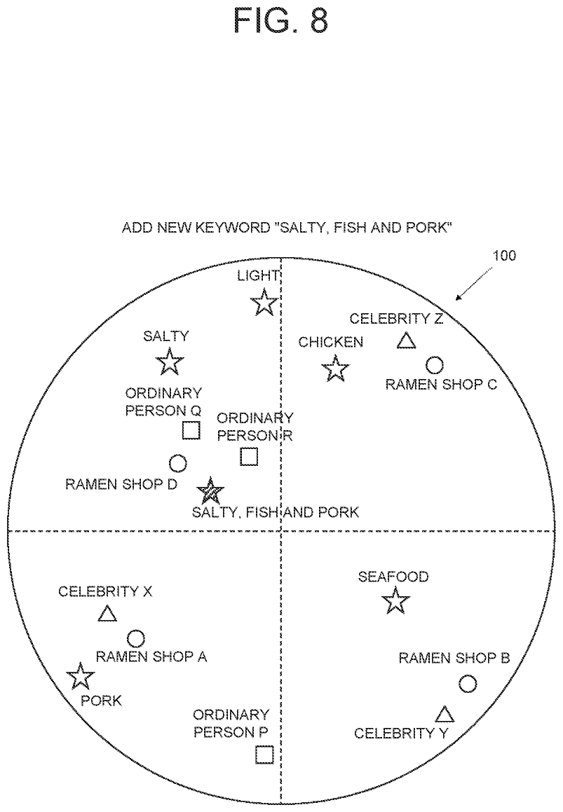

The evaluation data obtained with respect to the process target data (e.g., the keyword “salty, fish and pork” in the evaluations by the ordinary people Q and R about the ramen shop D) may be input as new process target data. When the new process target data is input, the coordinates of the process target data (salty, fish and pork) are determined and arranged on the evaluation map as shown in FIG. 8 in a manner analogous to that in the above description.

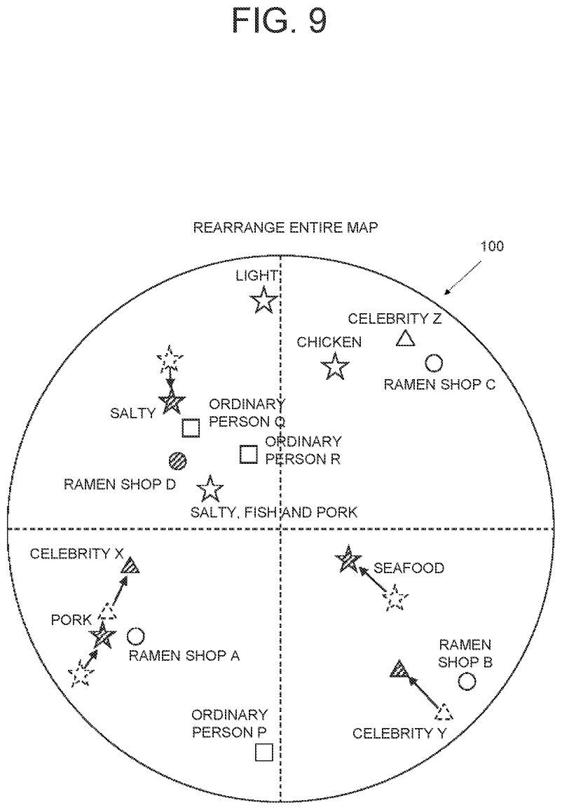

Furthermore, the evaluation map may be re-created (updated) according to the evaluation data. For example, if the popularity of the process target data is increased by the recommendation of the process target data (e.g., the ramen shop D), the entire evaluation map may be rearranged so as to be pulled to the process target data as shown in FIG. 9. Thus, as shown in FIGS. 3-9, the recommendation to a user of the custom relation management device (e.g., the ramen shop D) may be automatically moved to a different position on the evaluation map based on where the process target data is arranged and the evaluation data. As shown in FIGS. 3-9, the evaluation data may also be displayed on the user interface 100 of the customer relation management device. By displaying the evaluation map on the user interface 100, as shown in FIGS. 3-9, the visual spatial recognition may be improved for the users. When new information is obtained and input into the process target data, the coordinates for the updated process target data may be determined, and a new recommendation can be shown visually for a user. Thus, a specific user may obtain more accurate recommendations in various fields, such as a restaurant, movie, or music recommendation, using the customer relation management device 1.

In addition, a preference matching degree between the new information and a specific user of the custom relation management device 1 may also be displayed on the user interface 100 based on the evaluation data. For example, the preference tendency of the specific user and the preference tendency of an evaluator, such as “ordinary person P”, may be determined. If the preference tendency of the specific user is similar to the preference tendency of “ordinary person P”, the preference matching degree between the new information and the specific user will be shown as “highly matched” (i.e., “three stars”). For example, in FIG. 4, the evaluation data of the new information “ramen shop D” by “ordinary person P” is “high evaluation.” If the preference tendency of the specific user is similar to the preference tendency of “ordinary person P”, the preference matching degree between the new information “ramen shop D” and the specific user will be shown as “highly matched” (i.e., “three stars”).

On the other hand, if the preference tendency of the specific user is different from or opposite to the preference tendency of “ordinary person P”, the preference matching degree between the new information “ramen shop D” and the specific user will be shown as “poorly matched” (i.e., “zero stars”). For example, in FIG. 4, as noted above, the evaluation data of the new information “ramen shop D” by “ordinary person P” is “high evaluation.” If the preference tendency of the specific user is different from or opposite to the preference tendency of “ordinary person P”, the preference matching degree between the new information “ramen shop D” and the specific user will be shown as “poorly matched” (i.e., “zero stars”).

According to the customer relation management device 1 of such an embodiment, the information pertaining to customer relation management is arranged in the coordinate space on the evaluation map according to the evaluation result of the information. The evaluation map allows the analysis result to be easily and intuitively understood even by a person who is not an expert (even by an ordinary person). In a case where new information pertaining to customer relation management (process target data) is input, the information is temporarily arranged in the coordinate space on the evaluation map according to the evaluation result of the information, recommendation is performed on the basis of the temporarily arranged position (temporary coordinates), and subsequently the position (coordinates) where the information is to be rearranged is appropriately determined on the basis of the evaluation information (evaluation data) obtained with respect to the information. As described above, the result of recommendation based on the analysis result is reflected in the evaluation map. Accordingly, the result of the recommendation can be reflected in analysis thereafter.

According to this embodiment, as a result of the recommendation of the process target data, the evaluation information (evaluation data) obtained with respect to the information is input as new process target data and arranged on the evaluation map. Accordingly, not only the original information (process target data) but also the evaluation information (evaluation data) on the original information can be used for customer relation management.

In this embodiment, the evaluation map itself is re-created (updated) according to the result of the recommendation (evaluation data). Accordingly, the result of the recommendation can be reflected in the entire evaluation map.

In this embodiment, the recommendation is performed on the basis of the temporary coordinates on the evaluation map. On the evaluation map, the proximity between certain process target data and the position (coordinates) of arrangement in the coordinate space on the evaluation map means a high correlation with the process target data. In this case, the recommendation is performed on the basis of the recommendation list where pieces of information are arranged sequentially from the nearest to the temporary coordinates of the process target data. That is, the recommendation is performed sequentially from the nearest to the temporary coordinates of the process target data. Consequently, appropriate recommendation can be performed.

The embodiments of the present invention are thus described through the embodiments. However, the scope of the present invention is not limited to these examples, and can be changed and modified in conformity with the object within the range written in the claims.

For example, in the above embodiments, the description is given of the example where the customer relation management device is used for customer relation management in the ramen business. However, the customer relation management device of the present invention can be used for customer relation management in other various businesses (e.g., restaurant, fashion, photograph, automobile, cosmetics and healthy goods, movie, music software, television programs, game software, travel and hotel, etc.)

### INDUSTRIAL APPLICABILITY

As described above, the customer relation management device according to the present invention exerts advantageous effects that the analysis result can be easily and intuitively understood, and the result of the recommendation based on the analysis result can be reflected in analysis thereafter, is used for customer relation management that constructs relationships with customers and improves the customer satisfaction, and is useful.

### REFERENCE SIGNS LIST

1 Customer relation management device
2 Evaluation map creation unit
3 Process target data input unit
4 Temporary coordinate determination unit
5 Recommendation unit
6 Evaluation data obtaining unit
7 Coordinate arrangement determination unit
8 Evaluation map storage unit
9 Evaluation map update unit
10 Recommendation target extraction unit
11 Recommendation list creation unit
100 User interface

1. A customer relation management device, comprising:
a processor configured to:
create an evaluation map where information pertaining to customer relation management is arranged in a coordinate space with evaluation axes serving as a reference for evaluating the information, according to an evaluation result of the information with the evaluation axes being regarded as an index;
receive, after creation of the evaluation map, newly obtained information pertaining to customer relation management, as process target data;
determine temporary coordinates where the process target data is temporarily arranged in the coordinate space in the evaluation map created according to an evaluation of the process target data with the evaluation axes being regarded as an index;
recommend the process target data, based on the temporary coordinates on the evaluation map;
obtain, as evaluation data, evaluation information acquired with respect to the process target data, after the recommendation;
determine coordinates where the process target data are to be arranged in the coordinate space, according to the evaluation data, with respect to other coordinates in the evaluation map so as to reflect a result of the recommendation made based on the evaluation result; and
automatically move a recommendation for a user to a position on a user interface based on the evaluation data and the determined coordinates.

2. The customer relation management device according to claim 1, wherein the evaluation data is input as new process target data.

3. The customer relation management device according to claim 1, wherein the processor is further configured to re-create the evaluation map according to the evaluation data.

4. The customer relation management device according to claim 1, wherein the processor is further configured to:
create a recommendation list where pieces of the information pertaining to customer relation management arranged on the evaluation map are arranged sequentially from the piece nearest to the temporary coordinates of the process target data; and
recommend the process target data, based on the recommendation list.

5. The customer relation management device according to claim 1, wherein the processor is further configured to:
determine a preference tendency of the user of the customer relation management device based on the process target data;
determine a preference tendency of an evaluator based on evaluation data of the evaluator;
compare the preference tendency of the user to the preference tendency of the evaluator; and
display, on the user interface, a preference matching degree between the user and the evaluator based on the comparison.

6. A method executed in a customer relation management device,
wherein the customer relation management device creates an evaluation map where information pertaining to customer relation management is arranged in a coordinate space with evaluation axes serving as a reference for evaluating the information, according to an evaluation result of the information with the evaluation axes being regarded as an index, and
the method comprises:
determining, after creation of the evaluation map, temporary coordinates when newly obtained information pertaining to customer relation management is input as process target data, the temporary coordinates allowing the process target data to be temporarily arranged in the coordinate space in the evaluation map created according to an evaluation of the process target data with the evaluation axes being regarded as an index;
recommending the process target data, based on the temporary coordinates on the evaluation map;
obtaining, as evaluation data, evaluation information acquired with respect to the process target data, after the recommendation;
determining coordinates where the process target data are to be arranged in the coordinate space, according to the evaluation data, with respect to other coordinates in the evaluation map so as to reflect a result of the recommendation made based on the evaluation result; and
automatically moving a recommendation for a user to a position on a user interface based on the evaluation data and the determined coordinates.

7. The method according to claim 6, wherein the method further comprises:
determining a preference tendency of the user of the customer relation management device based on the process target data;
determining a preference tendency of an evaluator based on evaluation data of the evaluator;
comparing the preference tendency of the user to the preference tendency of the evaluator; and
displaying, on the user interface, a preference matching degree between the user and the evaluator based on the comparison.

8. The method according to claim 6, wherein the evaluation data is input as new process target data.

9. The method according to claim 6, wherein the method further comprises:
re-creating the evaluation map according to the evaluation data.

10. The method according to claim 6, wherein the method further comprises:
creating a recommendation list where pieces of the information pertaining to customer relation management arranged on the evaluation map are arranged sequentially from the piece nearest to the temporary coordinates of the process target data; and
recommending the process target data, based on the recommendation list.
